(19) United States
(12) Patent Application Publication
(10) Pub. No.: US 2003/0079234 A1
(43) Pub. Date: Apr. 24, 2003

(54) System and a method of producing a picture and/or sound signal on the background of the execution of multimedia content

(76) Inventor: Lars Blak Rasmussen, Stenlose (DK)

Correspondence Address: Finnegan, Henderson, Farabow,, Garrett & Dunner, L.L.P., 1300 I Street, N.W., Washington, DC, 20005-3315, US

(21) Appl. No.: 10/123,305

(22) Filed: Apr. 17, 2002

(30) Foreign Application Priority Data
May 9, 2001 (DK) PA 2001 00727
Oct. 19, 2001 (DK) PA 2001 01537

(51) Int. Cl. H04N 7/16

(52) U.S. Cl. 725/153

(57) ABSTRACT

This invention relates to a system for producing a frequency modulated picture and/or sound signal on the basis of execution of multimedia content, wherein the system comprises a first unit configured for receiving a sound signal and a picture signal from a multi-media terminal like a PC, computer, etc. configured for executing multimedia content, wherein the first unit is further configured for frequency modulating and combining said sound signal and picture signal to one single combined picture and sound signal, and a second unit configured for receiving said combined picture and sound signal and configured for combining said combined signal with at least one further signal resulting in a first signal.

Hereby a simple system is provided that will in a simple and efficient manner enable the provision of multimedia content from a computer, PC, etc, such that it can be displayed/played on one or more standard media apparatus(es) like a TV-set, a music-set, etc. where the system requires very little additional wiring and is easy to install. A wireless control unit may be used to alter and control the multimedia execution on the multimedia terminal.

Besides, the invention relates to a method of producing a picture and/or sound signal on the background of the execution of multimedia content, and a method/protocol for communication between a control unit and a wireless communication unit.

### FIELD OF THE INVENTION

This invention relates to a system of producing a frequency modulated picture and/or sound signal on the basis of the execution of multimedia content.

The invention further relates to a method of producing a frequency modulated picture and/or sound signal on the basis of the execution of multimedia content.

The invention additionally comprises a method/protocol for communication between a control unit and a wireless communication unit.

### BACKGROUND OF THE INVENTION

The spreading of Internet, digital (e.g. compressed) sound files, such as MP3- and WMA-files, and the like, Internet radio, digital multimedia broadcasting, digital photos, DVD-, DivX, and Avi-movies, streaming formats, etc, is steadily increasing. The home PC has to a wide extent been used as medium for exploiting these possibilities.

The increasing availability of broadband network connection also yields enhanced options for exploiting the above formats for entertainment at home. Including e.g. the option of downloading digital video movies and music from the net.

As a consumer one is limited by the sound and picture quality of one's PC at home as well as by its location in one's home. Besides, the typical PCs are not located conveniently for optionally a number of people being able to use the above-described facilities optimally. Today it is not generally possible to watch and hear/exploit these options on the existing standard sound and/or picture apparatuses at home (such as TV and music sets) that typically supply superior quality, e.g. in the form of larger screen area, superior sound, etc) and provides more liberal options as to where in one's home one wishes to watch and/or listen to what is desired in a simple and relatively inexpensive manner. Typical measures to integrate PC with TV and music sets involve comprehensive wiring and typically it is not possible to control the execution conveniently from a central place (other than by the computer as such).

A prior art system for enabling picture and sound generated on a personal computer to be displayed and played on a standard television via a home multimedia network is e.g. known from patent application WO 00/18054. The disclosed system is very complex and expensive to manufacture and would be quite hard for an average user to install. Additionally, specialised equipment (e.g. a IR receiver/emitter) has to be located at each display/playback device for e.g. reception and transmission of remote control commands, adding further to the cost and complexity of the system. This system is able to control each of the media devices of the system where each command is send from a control unit to the multi-media terminal and then to the specific media device further adding to the complexity of the system. No disclosure is given of enabling sound generated on a multimedia terminal to be transmitted to a music-set for playback in a simple manner.

Another patent specification U.S. Pat. No. 5,880,721 discloses a system for enabling picture and sound generated on a multimedia terminal to be relayed to a TV. More specifically, audio/video from a computer is converted and wireless transmitted to a TV for presentation/display. This system is a point-to-point (P2P) system and requires specialised and expensive hardware (UHF antennas) at the computer and the TV. The wireless remote control of the applications on the computer is preferably done by a standard wireless keyboard and mouse where the infrared (IR) signal is received and converted at the UHF antennas and transmitted between these from the mouse/keyboard to the computer. The user interface that a user of this system is being presented with is exactly the same user interface as on the computer, thereby requiring mouse and keyboard. Since IR communication is used, the user has to stay within a relatively limited range of the UHF antenna at the TV in order to be able to control the applications on the computer.

### OBJECT AND SUMMARY OF THE INVENTION

It is an object of the invention to provide a system that will, in a simple and efficient manner, enable the provision of multimedia content from a multimedia terminal, computer, PC, etc, whereby it can be played/displayed/executed on one or more standard media apparatus(es) like TV-sets, music-sets, etc.

It is a further object to enable the provision of a multimedia content on one or more standard apparatus(es) using already existing cabling in a house to a great extent.

It is a further object of the present invention to provide a system for providing multimedia content on one or more standard apparatus(s) that has a relatively low complexity and a relatively cheap manufacturing cost.

An additional object of the present invention is to provide a system that allows a user to easy control multimedia content on a multimedia terminal using a relatively simple controller whit low power consumption.

A further object is to provide a system for providing multimedia content being run on a computer/multimedia terminal to standard display/play apparatus(es) that is easy to install for a user.

An additional object is to enable provision of multimedia content on standard devices while keeping the existing TV and/or radio channels (if any) available.

These objects and others are obtained by a system of the kind described above, wherein said system comprises

a first unit configured for receiving a sound signal and a picture signal from a multimedia terminal configured for executing multimedia content, wherein the first unit is further configured for modulating and combining said sound signal and picture signal to one single combined picture and sound signal; and

a second unit configured for receiving said combined picture and sound signal and configured for combining said combined signal with at least one further signal resulting in a first signal.

Hereby a system is provided that enables the display and/or execution of multimedia-based contents executed on a computer/multimedia on a number of standard display/playing products, such as e.g. TV and/or music sets.

Further, the above system can be provided with a minimum of further cabling, the combined signal being combined with a further signal, where—typically—cabling already exists from the further signal to the remainder of the standard display/playing products.

Also, the system can replace CD-player, DVD-player, radio, TV, etc, and other set-top boxes, since these items can be executed on the multimedia terminal as long as the multimedia information is present in digital form. These items requires that the multi-media content is stored on or accessible by (e.g. via a network) the terminal or that suitable hardware is installed in the multimedia terminal, e.g. a DVD-drive, a CD-drive, etc.

Besides, all multimedia (DVD, CD, Broadband content, WebCam, Internet Web pages, pictures, Internet radio, Internet Broadcasting, Streaming, etc) can be used on all TV and radio apparatuses at home as opposed to e.g. existing set-top boxes that are able to operate only on a TV and/or radio apparatus.

Additionally the system provides flexibility since the functionality of software applications on the multimedia terminal can be updated continuously merely by download of up-dated program information.

Preferably said multimedia terminal is provided with means for producing analog sound and/or picture signals, such as e.g. a sound card and/or a VGA video card with TV output. As the system simply receives a picture signal output from the multimedia terminal the part of providing sound and picture to existing media devices (TV, music-set, etc.) is independent on the technology (e.g. VGA) used in the terminal to display pictures in the normal way. Alternatively, said computer may comprise means for producing digital sound and/or picture signals, such as a sound card with digital sound input/output. Such sound and VGA video cards are very well known.

The combined picture and sound signal can be transmitted from the first to the second unit via one or more cables, a wireless connection, etc. Preferably, a standard hard wired coaxial cable is used.

Said multimedia content can comprise e.g. one or more selected from the group

a DVD picture and sound signal;

a CD sound signal;

a given digital audio format (e.g. MP3, WMA, Real Audio, WAV, etc);

a given digital movie format (e.g. DivX, DVD/MPEG2, Avi, MOV, Real Video, etc);

a given picture format (e.g. JPEG, GIF, BMP, TIFF, etc); and/or

any such format that is capable of causing a computer to emit a picture and/or sound signal.

The multimedia content may be executed on the computer e.g. from storage media, such as a hard disk, RAM, flash media, CD-ROM, CD-R, CD-RW, DVD, DVD-RAM, etc., or directly from a network and/or internet connection or other external sound and/or picture generating sources e.g. a web-cam.

According to a preferred embodiment the above at least one further signal comprises at least one or more signals selected from the group of:

a TV antenna signal; and

a radio antenna signal.

Hereby existing normal radio and TV programs can be executed/selected simultaneously with the option of multimedia-based contents from the computer being executed.

According to a further preferred embodiment the system further comprises said multimedia terminal; a wireless communication unit in communications connection with said multi-media terminal and comprising a wireless receiver/transmitter; and a wireless control unit comprising operation means and a wireless receiver/transmitter and configured for two-way wireless communication with said communication unit; wherein said control unit is configured to control said execution of multimedia content on said terminal via communication with said communication unit and a software application installed on said multimedia terminal.

Hereby it is possible to operate and control the execution of multimedia content and thereby indirectly the display and/or playing on e.g. the TV or the music set in a convenient manner via one single central unit. In this manner, the multimedia terminal that executes the multimedia content can be placed in any random location at home and be operated from any other random location.

Besides, one single control unit is able to control multimedia execution on all display/playing units. Hereby all other remote controls for various devices are rendered redundant. Several control units may be used, if desired, but each may replace the normal remote controls.

Preferably the wireless communication is radio-based.

According to a preferred embodiment said control unit is configured for communicating with said wireless communication unit according to a simple protocol, where simple control codes and/or ID codes are transmitted to said multimedia terminal for receipt and processing by said software application, wherein said software application is configured for execution and/or changing the execution of said multimedia content based on the received control and/or ID codes. Further the processing may consist of control of sender, receiver, cryptography/inverse cryptography, wrapping/unwrapping of data, error-correction, etc.

Hereby, a simple communications protocol is obtained, wherein the functionality is determined by the software application. This greatly improves the options of updating, further developing, maintaining, etc, the functionality of the system in a very easy manner. Additionally, the major part of the necessary resources spent is also provided for in the multimedia terminal. Hereby the control unit can be kept relatively simple with ensuing increased battery longevity.

According to one embodiment said system further comprises at least one display and/or playing unit that is configured for receiving and displaying and/or playing said first signal. By frequency modulating multimedia content to a TV-channel and/or a radio-channel enables the provision of the content on standard TV-sets and music-sets without modification and further cabling of/for these since they are already provided for receiving signals like this.

According to one embodiment said at least one display and/or playing unit comprises one or more from among

a TV set;

a video player; and

a music set.

Other display and/or playing units could be e.g. a projector, a monitor, or any other kind of units that is configured for receiving a sound and/or picture signal for displaying, playing, executing, etc, this signal.

In one embodiment, the first unit comprises a TV modulation unit, adapted to receive said picture signal and said sound signal from said multimedia terminal and modulate said picture signal and said sound signal resulting in a frequency modulated picture and sound signal, a radio modulation unit, adapted to receive said sound signal from said multimedia terminal and modulate said sound signal resulting in a frequency modulated radio signal, and a combination unit adapted to combine said modulated picture and sound signal and said modulated radio signal into said single combined picture and sound signal.

In one embodiment, the TV modulation unit is adapted to modulate said picture and sound signal to the UHF frequency area, and said radio modulation unit is adapted to modulate said sound signal to the FM-radio frequency area.

In one embodiment, the second unit comprises a combination unit connected to receive said further signal, comprising TV and radio signals, and said combined signal where said combination unit is adapted to combine said further signal and said combined signal resulting in said first signal comprising existing TV and radio signals and a frequency modulated version of said multimedia signal being executed on said multimedia terminal.

In one embodiment, the second unit comprises a band-pass filter connected to receive said combined signal where said filter is adapted to filter out a picture part of said combined signal resulting in a filtered sound signal, a first combination unit connected to receive said combined signal and said further signal, comprising TV signals, where said first combination unit is adapted to combine said further signal and said combined signal resulting in said first signal comprising existing TV signals and a frequency modulated version of said sound and picture signal being executed on said multimedia terminal, a second combination unit connected to receive said filtered sound signal and said further signal, where said second combination unit is adapted to combine said further signal and said filtered sound signal resulting in said first signal comprising existing radio signals and a frequency modulated version of said sound signal being executed on said multimedia terminal.

It is a further object of the invention to provide a method having the same advantages for the same reasons as said system.

This is provided by a method of producing a frequency modulated picture and/or sound signal on the basis of execution of multimedia content on a multimedia terminal, wherein said method comprises

receiving a sound signal and a picture signal from a multimedia terminal configured for execution multimedia content;

frequency modulation and combination of said sound signal and picture signal to one single combined picture and sound signal; and

combination of said combined signal with at least one further signal resulting in a first signal.

According to a preferred embodiment, the method further comprises

wireless communication between a wireless communication unit connected to the multimedia terminal; and a wireless control unit comprising operating means,

wherein said control unit controls and/or checks said execution of multimedia content on said multimedia terminal via communication with said communication unit and a software application installed on said multimedia terminal.

According to a preferred embodiment the method further comprises wireless communication between said control unit and said wireless communication unit according to a simple protocol, wherein simple control codes and/or ID codes are transmitted to said multimedia terminal for receiving and processing by said software application; and wherein the application is configured for execution and/or changing the execution of said multimedia content based on the received control and/or ID codes.

According to a preferred embodiment, the method further comprises receipt and display and/or playing of said first signal in at least one display and/or playing unit.

The embodiments of the method have the same effect for the same reasons as was the case with the corresponding embodiments of the system, and therefore they are not subject to renewed description.

In one embodiment, said first unit comprises a TV modulation unit receiving said picture signal and said sound signal from said multimedia terminal and modulating said picture signal and said sound signal resulting in a frequency modulated picture and sound signal, a radio modulation unit receiving said sound signal from said multimedia terminal and modulating said sound signal resulting in a frequency modulated radio signal, and a combination unit combining said modulated picture and sound signal and said modulated radio signal into said single combined picture and sound signal.

In one embodiment, said TV modulation unit modulates said picture and sound signal to the UHF frequency area, and said radio modulation unit modulates said sound signal to the FM-radio frequency area.

In one embodiment, said second unit comprises a combination unit receiving said further signal, comprising TV and radio signals, and said combined signal where said combination unit combines said further signal and said combined signal resulting in said first signal comprising existing TV and radio signals and a frequency modulated version of said multimedia signal being executed on said multimedia terminal.

In one embodiment, said second unit comprises a band-pass filter receiving said combined signal where said filter filters out a picture part of said combined signal resulting in a filtered sound signal, a first combination unit receiving said combined signal and said further signal, comprising TV signals, where said first combination unit combines said further signal and said combined signal resulting in said first signal comprising existing TV signals and a frequency modulated version of said sound and picture signal being executed on said multimedia terminal, a second combination unit receiving said filtered sound signal and said further signal, where said second combination unit combines said further signal and said filtered sound signal resulting in said first signal comprising existing radio signals and a frequency modulated version of said sound signal being executed on said multimedia terminal.

Additionally, the invention also relates to a protocol for communication between a wireless control unit and a multimedia terminal wherein the protocol comprises:

simple control codes that are transmitted from said wireless control unit to said multimedia terminal for reception and processing by a software application on said multimedia terminal; and

wherein said software application is configured for execution and changing the execution of said multimedia content based on the received control codes.

Further, the invention also relates to a computer readable medium having stored thereon instructions for causing one or more processing units to execute the method according to the invention.

Alternatively one or more of the above units can be integrated as a plug-in card for the PC/the multimedia terminal whereby external units are avoided and said combined picture and sound signal is provided directly by the computer. The communication from the plug-in card can be e.g. wireless, via one or more cables, etc.

Besides, the system can also be changed/modified to work with digital units (e.g. from a digital output from CD-ROM, DVD drive, sound card) until it is to be modulated with said at least further signal (e.g. the TV/radio signal). Alternatively, it can be digital all the way if the normal TV/radio signal is present in digital signal format, wherein these signals are to be combined, multiplexed, etc.

As a further alternative the first unit may comprise a VGA input or the like and means for converting a monitor/VGA signal to an analogue signal. Hereby it is avoided that the computer must be provided with a TV output as such. As yet a further alternative the first unit may comprise a digital monitor input. Additionally, one or more of the units may also be adapted to wireless receive/transmit signal(s).

### BRIEF DESCRIPTION OF THE DRAWINGS

The invention is explained in further detail, and by way of example, with reference to the accompanying drawings wherein:

FIG. 1a shows a schematic block diagram of an embodiment of a system according to the invention;

FIG. 1b shows a schematic block diagram of an alternative embodiment of the system according to the invention;

FIGS. 2a, 2b and 2c show embodiments of a first and a second unit according to the invention;

FIG. 3 illustrates an embodiment of a communication interface according to the invention;

FIG. 4a shows an embodiment of a wireless control unit according to the invention;

FIG. 4b shows an alternative embodiment of a wireless control unit according to the invention;

FIGS. 5a and 5b illustrate examples of menus presented on a wireless control unit according to the invention;

FIGS. 6a through 6c illustrate examples of communication according to a preferred protocol;

FIG. 7 illustrates a flowchart of an embodiment of a method according to the invention;

FIG. 8 schematically shows the communication between a control application on a multimedia terminal, a wireless control unit and a series of applications for execution/playing multimedia content;

FIG. 9a illustrates an alternative embodiment of a first unit according to the invention;

FIG. 9b shows the embodiment from FIG. 9a from another angle;

FIG. 9c illustrates an alternative embodiment of a communications interface according to the present invention;

FIG. 10a illustrates a schematic diagram of an embodiment of a first unit according to the present invention;

FIG. 10b illustrates a schematic diagram of an embodiment of a second unit according to the present invention;

FIG. 10c illustrates a schematic diagram of an embodiment of a communication interface according to the present invention;

FIG. 10d illustrates a schematic block diagram of a one embodiment of a multimedia terminal.

### DETAILED DESCRIPTION OF THE INVENTION

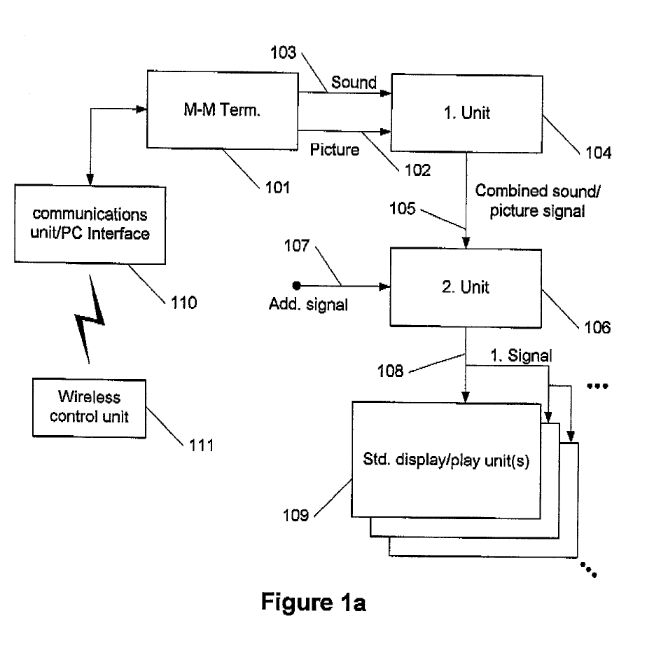

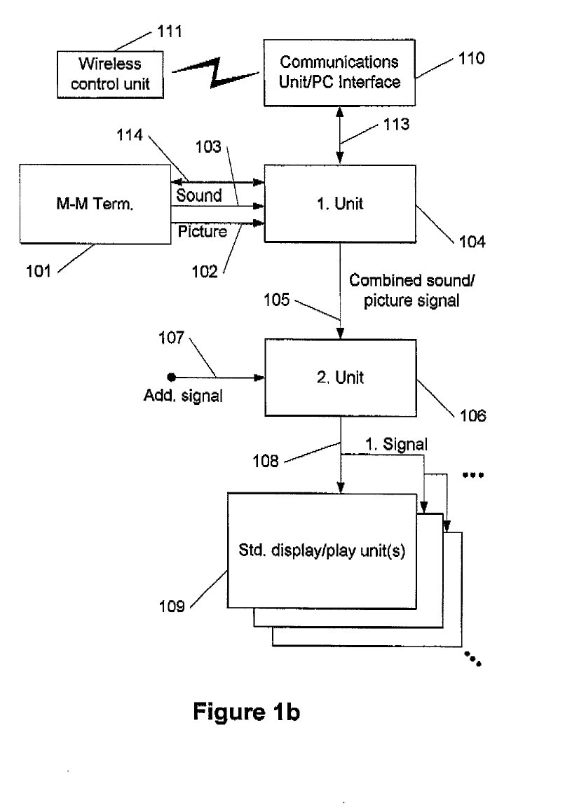

FIG. 1 shows a schematical block diagram of an embodiment of the system according to the invention. Shown in the figure is a multimedia terminal (101) for execution of a digital multimedia content/information, such as e.g. music, pictures, video, Internet radio, homepages, etc, resulting in a picture (102) and/or sound signal (103). Preferably the multimedia terminal (101) is a standard PC, computer, etc, equipped with means for producing analog sound and/or picture signals, such as e.g. a sound card and/or a VGA video card/display adapter with TV output. Alternatively said terminal (101) can be equipped with means for producing digital sound and/or picture signals. Such sound cards and video cards (both analogue and digital) are well known.

The multimedia terminal (101) comprises multimedia software and/or hardware applications for execution various types of multimedia content and a control application for controlling and checking same and the execution of a current multimedia content via a given multimedia application.

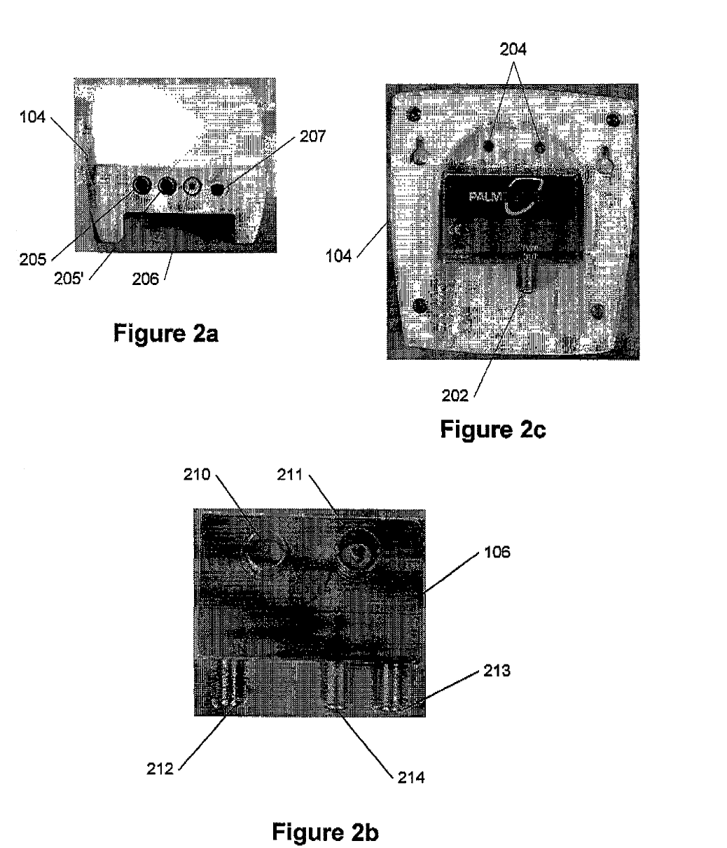

The terminal (101) is connected to a first unit/a signal combiner (104) whereby the resulting picture and/or (stereo) sound signal (102; 103) can be received in the first unit (104) in which they are modulated and combined to one single combined sound/picture signal (105). See FIGS. 2a, 2c, 9a and 10 for embodiments of a first unit.

Preferably said sound signal (102) and picture signal (103) are frequency modulated, if they are analog signals, to form the combined picture and sound signal (105), preferably in the form of a standard TV signal comprising stereo sound that can be used readily on standard playing/display units that normally receive a signal from a standard TV antenna arrangement. Alternatively the two signals (102; 103) are multiplexed if they are digital signals. If one of the signals (102; 103) is analog, whereas another is digital, the first unit (104) may comprise a converter (e.g. A/D or D/A converter, whereby the signals (102; 103) can be brought to same form (either analog or digital).

Preferably said first unit (104) also comprises one or more amplifier circuits (not shown) for amplifying the combined sound/picture signal (105).

The combined sound/picture signal (105) is received by a second unit/an antenna distributor (106), wherein it is combined with one or more optional further/additional signals (107) resulting in a first signal (108). In this way, the first signal (108) comprises the sound and/or picture signal generated by the multimedia terminal in a standard frequency modulated TV and radio channel version so that these signal may be viewed and/or played on a music-set and/or a TV-set simply by feeding the first signal (108) to such a set and tune a channel to the appropriate frequency in the normal way.

The second unit (106) serves as a joining link of the sound/picture signal of the multimedia terminal (101) and e.g. an existing antenna arrangement, preferably in the form of a coupling filter.

The further signal (107), if any, preferably comprises an analog or digital TV antenna signal and/or a radio antenna signal, e.g. from an antenna, cable, etc. arrangement (not shown) already in existence at home. Hereby existing radio and TV programs can be shown, played, selected, etc. in the normal fashion on standard TVs, music-sets, etc. and at the same time having the option of showing and/or playing multimedia-based content being executed at the terminal (101) on the same standard TVs, music-sets, etc. as a separate standard TV and/or radio channel.

Alternatively, the second unit (106) may contain an antenna for transmitting and receiving commands and video/sound to/from the first unit (104) whereby transmission of video/sound becomes wireless. Likewise the second unit may comprise a connection to a network and/or an optical fibre.

The further signal (107) is preferably provided via a standard coax antenna cable.

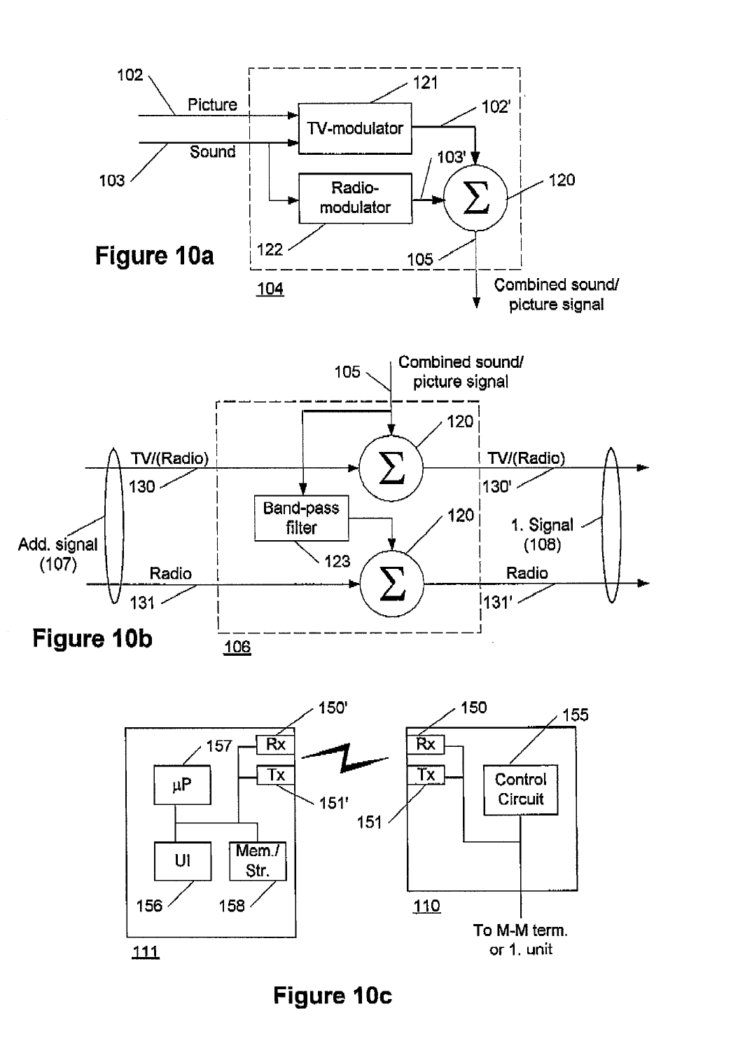

The further signal (107) and the combined signal (105) are combined/added e.g. using a coupling filter, which is explained in greater detail in connection with FIG. 10b.

The second unit (106) is connected to one or more standard display/playing units (109) whereby the first signal (108) (that comprises the combined sound/picture signal (105) and optionally further signals (107)) is transmitted thereto (109) via existing cabling for being provided via a standard antenna input and executed/played thereon.

Preferably, the combined picture/sound signal (105) and the first signal (108) are transmitted via a standard coax cable to the various standard media devices of a home, e.g. TV-set(s), music-set(s), etc. or in general any device capable of generating (e.g. using converters) a sound or a picture on the basis of a standard television or radio signal. This cabling would typically already exist in a home for providing the normal TV and/or radio channels to the standard devices.

Examples of standard display/playing units include e.g. one or more from among a TV-set, a video player, a music set, a projector, a monitor, or any other unit that is configured for receiving a sound and/or picture signal in order to display, play, execute, etc. this signal.

Embodiments of a second unit (106) is shown and explained in connection with FIGS. 2b and 10b

In this manner a system is provided that will, in a simple and efficient manner, enable the provision of multimedia content form a computer, PC, etc, in order to thereby allow display/playing thereof on one or more standard apparatus(es) like a TV-set, a music set, etc.

The additional hardware and wiring required to enable this is the first and second unit and wiring between the multimedia terminal (101) and the first unit (104), between the first (104) and the second unit (106). The wiring comprising the additional signal to the standard display/play unit(s), i.e. the wiring required for showing television on TVs and for playing radio on a music set, already exists in typical homes. The system is very easy to install as it only requires connection of the first unit (104) with the audio/video output of the multimedia terminal (101), insertion/connection of the second unit (106) at/to a TV/radio inlet, a drop, etc., i.e. usually the coax connecter through which an antenna or cable signal is delivered at a home, connection between the first (104) and second unit (106), and connection of the second unit (106) to the existing cables to the standard display/play devices (109).

According to a second embodiment the system further comprises a wireless control unit (111) and a wireless communication interface/a wireless communication unit (110). The control unit (111) and the interface (110) are preferably in wireless communication with each other in accordance with a predetermined protocol. According to a preferred embodiment, the transmission between the communication unit (110) and the control unit (111) is a two-way, wireless 433 MHz/434 MHz communication. Alternatively, communication at other frequencies may be used. Transmission between the communication unit (110) and the terminal (101) may be effected e.g. via a network card/adapter, serial, parallel or USB port or the like on the terminal (101).

The control unit (111) is equipped with a user interface (not shown) whereby the user is able to activate/perform a number of predetermined commands, such as play, stop, pause, next, previous, selection of playing unit/application at the multimedia terminal (101), etc. Each option, command, etc, is preferably associated with a predetermined unique code in accordance with the predetermined protocol, thereby allowing for a very simple protocol and control unit (111). In this way, most of the needed processing capabilities with respect to the execution of multimedia content and control thereof are kept at the terminal (101). The control unit (111) simply has to transmit an appropriate code reflecting an intended command, instruction, selection etc. to the terminal (101) for further interpretation, processing, etc. in response to a user command, selection, etc.

A given code reflecting a given command is transmitted wirelessly by activation via the user interface to the communication interface (110) for further transmission and processing in the terminal (101).

Hereby simple control of the execution of multimedia content being run on a terminal (101) and showed/played on a standard display/play unit (109) is obtained thereby enabling a simple construction of the control unit (111) and thus also a low consumption of power.

The communication interface (110) is preferably electrically connected to the multimedia terminal (101), e.g. via a standard USB (Universal Serial Bus), parallel or serial connection, whereby simple control codes/commands can be transferred to the terminal (101) for executing or changing an execution of multimedia content. Alternatively, the interface (110) can be integrated as standard plug-in/expansion card for the terminal (101) or be connected to a standard network adapter connected with the terminal (101).

Preferably, the communication between the wireless control unit (111) and the terminal (101) (and thereby the communications unit (110)) is two-way. This allows for feed-back being presented to a user, e.g. after activation of a command, and for the presentation of additional information, e.g. the title of a song being played on a music-set or a video being played on a TV-set. This feedback may be displayed on a display on the control unit (111) and/or be overlayed on the computer generated picture and thereby visible on a TV-set.

Additionally, the two-way communication also provides for enhanced transmission security as the two-way communication allows for acknowledge of transmitted/received information communicated between the terminal (101) and the control unit (111) as well as error-correction and cryptography.

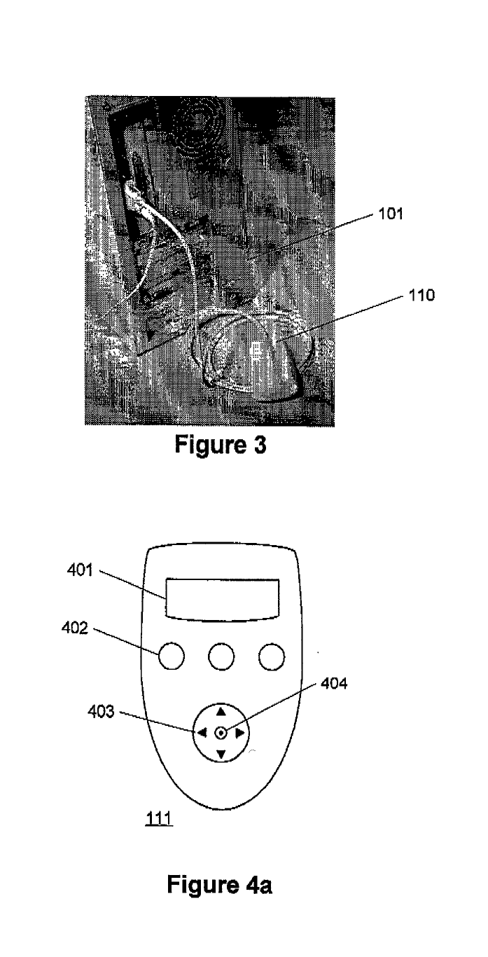

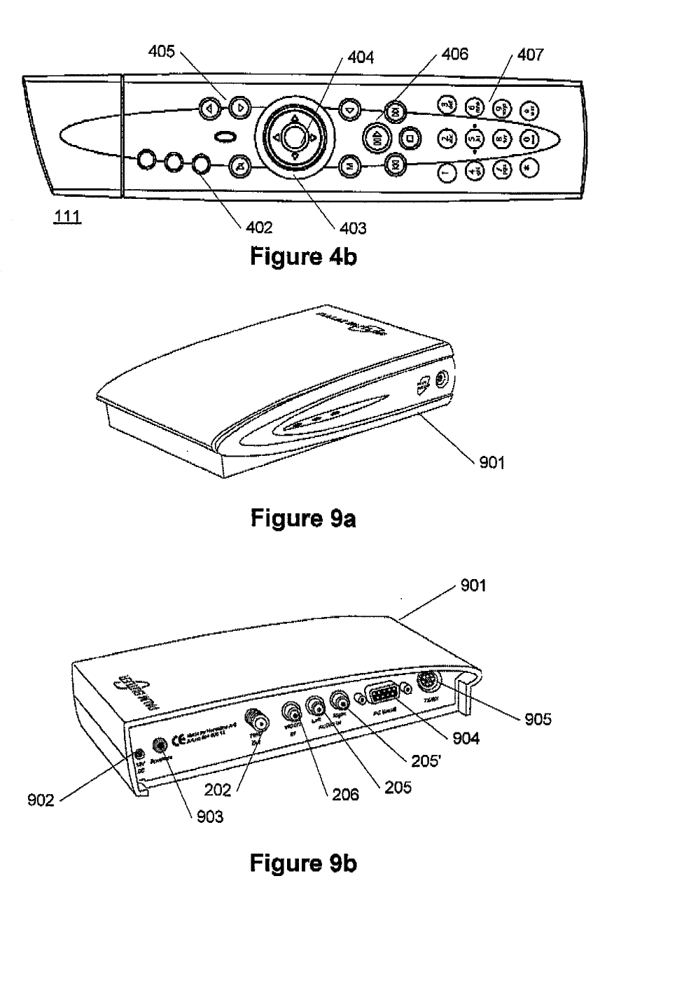

Examples of a wireless control unit (111) are shown in FIGS. 4a and 4b, whereas an example of a communication interface (110) is shown in FIGS. 3 and 9c.

Alternatively, the communication unit (110) may be configured as a plug-in or expansion card for a multimedia terminal (101). In that case, the communication takes place via an internal data bus in the terminal (110). Furthermore the communication unit (110) may also be integral with or connected to the first unit (104).

Preferably the multimedia terminal (101) is a standard PC with a standard VGA display adapter comprising TV output and a sound card with analog or digital stereo or surround sound output. Preferably the PC is equipped with a DVD drive and/or a CD-ROM drive/writer, as well as an Internet connection. Besides the PC is preferably featuring multimedia execution applications, such as e.g. WinAmp, WinDVD, MS Media Player, Browser software, etc.

FIG. 1b shows a schematic block diagram of an alternative embodiment of the system according to the invention. The shown embodiment corresponds to the embodiment shown in FIG. 1a except that the communications unit (110) is connected (113) with the first unit (104) which is connected (114) to the multimedia terminal (101) instead of a direct connection between the communications unit (110) and the terminal (101) as shown in FIG. 1a.

FIG. 2a shows two illustrations of an embodiment of a first unit according to the invention. Shown is a first unit (104) comprising an analog sound input (205; 205′) (herein shown in the form of separate right and left sound inputs) for receiving the sound signal from the multimedia terminal. Further shown is a video/TV/picture input (206) here in the form of a composite video IN input for receiving the picture signal from the multimedia terminal. Also shown is an adapter input (207) for connection to a power source/adapter (not shown).

Also shown is a combined sound/picture output (202) for the combined sound/picture signal (105 in FIGS. 1a and 1b). Preferably the first unit (104) also comprises adjustment means (204) that can be manipulated with in order to fine-tune the interface to a certain TV channel and/or a radio channel.

Alternatively inputs (205) and (205′) can be combined in one single input. Besides input (206) can be another type of digital or analog output, e.g. RGB, D-Sub, etc., directly from an output of a VGA graphics adapter in the multimedia terminal (101).

FIG. 2b shows an embodiment of a second unit according to the invention. Shown are a TV/picture and radio input (212) and a sound/radio input (213) for receiving the further signal (107 in FIGS. 1a and 1b) as explained above. The TV/Picture signal on input (212) can be connected e.g. to an antenna arrangement, a drop, etc. via one single plug (both sound and picture). The signal on input (213) can be connected to a radio antenna plug (stereo sound only). Typically both inputs (212, 213) will be used for antenna arrangements with two plugs, whereas input (212) is typically used for antenna arrangements with a single plug only.

Also shown is a TV/PictureNideo output (210) for emitting the first signal (108 in FIGS. 1a and 1b) in TV channel format (containing both sound and picture e.g. during playing a film) and a sound/radio output (211) for emitting the sound part of the first signal in a radio channel format.

Shown is also an input (214) for receiving a combined sound/picture signal (105 in FIGS. 1a and 1b) from a first unit (104). This combined signal is modulated/multiplexed with signal from inputs (212) and (213) and result in the signal on outputs (210) and (211) as described in greater detail in connection with FIG. 10b.

Generally, the system is connected by unplugging the coax connector of the existing standard display/play devices from the existing antenna/cable arrangement and then connecting the second unit to the antenna/cable arrangement (to input 212 and/or input 213) and the antenna connector of the existing standard devices is connected to output (210) and everything is like before the connection of the system according to the present invention, with the exception of the inclusion of multimedia content, being executed on the multimedia terminal, as a TV/radio-channel. In this way, both video (sound and picture) for a TV and sound for a radio are outputted from (210) but only sound for a radio is outputted from (211). It is possible, if desired, to convert an existing antenna arrangement with one connector (comprising both picture and sound) to an arrangement with two connectors (one comprising picture and sound (210) and one comprising sound only (211) by using a second unit (106) according to the present invention.

FIG. 3 illustrates an embodiment of a communication interface according to the invention. Shown is a multimedia terminal (101) and a wireless communications interface (110) that function as described earlier.

In a preferred embodiment the transmission between the communication unit (110) and the control unit (111) is a two-way wireless 433 MHz/434 MHz communication. Transmission between the communication unit (110) and the terminal (101) can take place e.g. via a network adapter or via a serial, parallel or USB connector or the like on the terminal (101).

FIG. 4a shows an embodiment of a wireless control unit according to the invention. Shown in the figure is a wireless control unit (111) that comprises a user interface comprising in this example a display (401) for displaying information, options, a menu, feedback, etc., operating buttons (402) for quick choice/selection of current menu items shown in the display (401), and a navigator (403) for navigating between options in a menu or between menus, and an ‘OK’ button (404) for selection of a current command, multimedia file, file shown in a menu.

Preferably, the graphical user interface shown in the display (401) is divided into an information portion that shows options in the form of what can be selected of folders and/or multimedia files and a menu bar that shows which menu items that can be selected by means of the operating buttons (402).

Preferably the navigation means (403) is configured for scrolling up/down among the options in the information portion and right/left in the current menu bar, if e.g. it contains more menu items than can be shown in the display at a time.

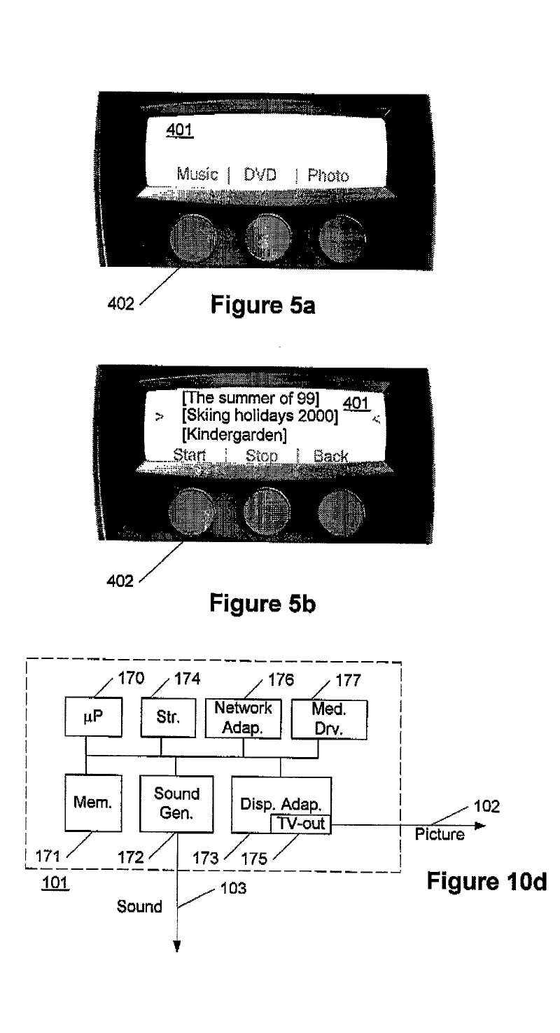

FIGS. 5a and 5b show examples of menus shown in the display (401).

Further the wireless control unit (111) comprises a wireless communication transceiver (not shown) for two-way wireless communication with a communication unit according to the invention (110 in FIGS. 1 and 3). Preferably the wireless communication is radio-based (RF).

Alternatively a control unit can be without display, where the representation of commands and information is controlled by the control application executed on the multimedia terminal and given via a TV screen. In this embodiment the TV screen will constitute the display for the control unit.

FIG. 4b shows an alternative embodiment of a wireless control unit according to the invention. In this embodiment, the control unit (111) itself is without a display but where the representation of commands and information is given via a TV screen, the representation being controlled by the control application executed on the multimedia terminal. In this embodiment the TV screen will constitute the display for the control unit. Shown in the figure is a wireless control unit (111) that comprises a user interface comprising operating buttons (402) for choice/selection of current menu items shown on a TV-set, and a navigator (403) for navigating between options in a menu or between menus, and an ‘OK’ button (404) for selection of a current command, multimedia file, file shown in a menu.

Preferably, the user interface comprises volume up/down buttons (405) and special buttons for accessing often used commands (406) like ‘play’, ‘stop’, ‘next’, ‘pause’, etc. for easy access by a user. Preferably, the user interface also comprises alphanumeric keys (407) for e.g. easy selection of track ‘1’, ‘15’, etc.

Further the wireless control unit (111) comprises a wireless communication transceiver (not shown) for two-way wireless communication with a communication unit according to the invention (110 in FIGS. 1 and 3). Preferably the wireless communication is radio-based (RF).

FIG. 5a shows a display with a menu bar containing three menu items (optionally containing other sub-menus) (‘Music’, ‘DVD’, ‘Photo’). One of these can be selected by activating the associated operating button (402), i.e. the button arranged most proximate to the menu item.

FIG. 5b shows a display (401) with another exemplary menu. Shown is a menu bar with three menu items containing commands (‘Start’, ‘Stop’, ‘Back’) and an information portion containing options (‘The summer of 99’, ‘Skiing holidays 2000’, ‘Kindergarten’). The content of these labels is preferably transmitted to the control unit (111) from a controlling software application on the multimedia terminal. A navigation button, wheel, etc. (e.g. 403 in FIG. 4a) can be used to navigate among the options, while an associated operating button (e.g. 402 in FIG. 4a) can be used to execute the associated command on the currently selected option (herein ‘Skiing holidays 2000’).

In order to make a system according to the invention perform satisfactory, it is necessary that the communication between a wireless control unit (111) and a multimedia terminal (101) can be done in a fast and secure way, thereby requiring a protocol, which ensures no interference from other systems of the same nature or by systems of other kinds using wireless communication in the same frequency-band.

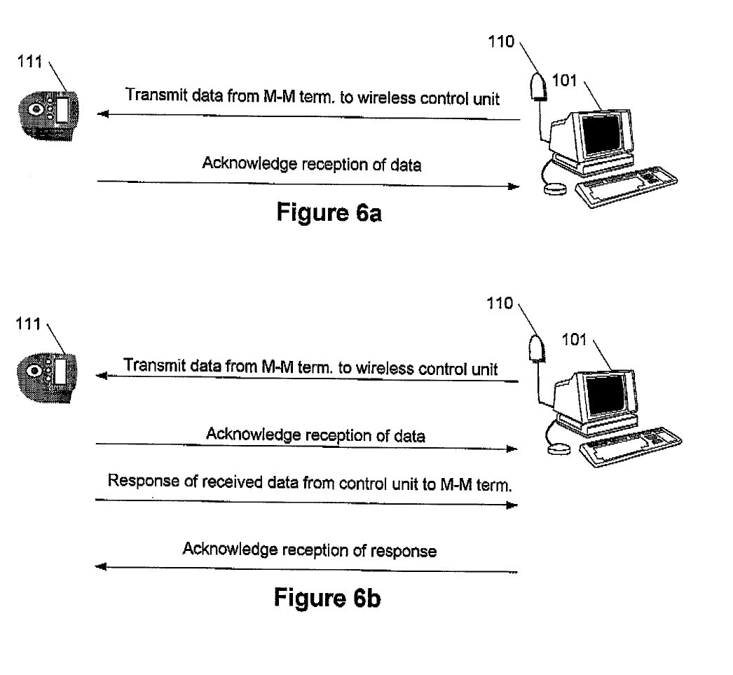

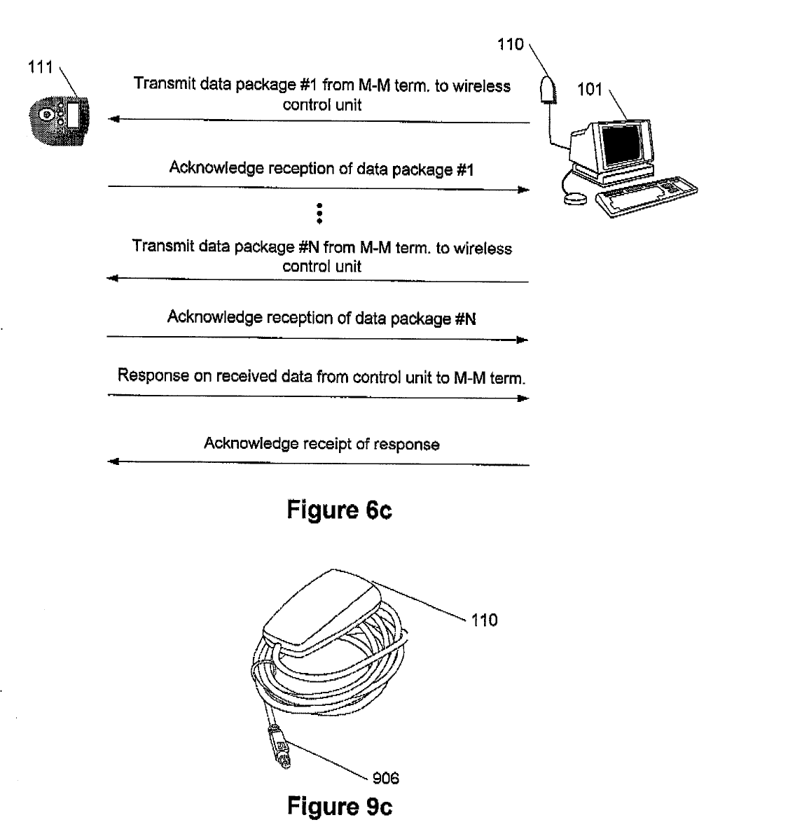

FIGS. 6a-6 illustrate examples of communication according to a preferred protocol.

FIG. 6a shows an example of a data transmission from a control application on a multimedia terminal (101) via a communication unit (110) for a wireless control unit (111) without expected response. First, data are transmitted from the multimedia terminal (101) that will, following receipt by the wireless control unit (111), effect transmission of a confirmation of data received to the control application on the multimedia terminal (101).

One example of data is e.g. a display update information, i.e. data representing what should be displayed on the control unit (111), where the update information is sent to the wireless control unit (111), which may transmit back a receipt, acknowledge, etc. for the proper reception of data to the multimedia terminal (101) in order to enhance the safety of data transmission. This is e.g. used in connection with a multimedia application playing a movie, music, etc. on the multimedia terminal (101), which may cause a need for an update of information, like title, time used/left, total play time, etc., being displayed on the wireless control unit (111).

If no such confirmation is received, e.g. due to data not arriving or contained errors (can be determined via check sum, CRC, etc), following a given time interval, the control application can attempt to resend the data.

FIG. 6b shows an example of a data transmission from a control application on a multimedia terminal (101) via a communication unit (110) for a wireless control unit (111) with expected response. The two first steps correspond to the two steps given in FIG. 6a. Following transmission of a confirmation of data received, a response based on the data received (and optionally other) will be generated and transmitted to the control application on the multimedia terminal (101), which will subsequently transmit a confirmation of receipt of response.

If such response or data are not received, retransmission as described above can take place.

One example of data and response is e.g. in connection with the registration of a wireless control unit (111) to a multimedia terminal (101) so that the terminal (101) is able to communicate with this particular control unit (111). This allows for several control units (111) being assigned for a single terminal (101). The terminal (101) will send a demand for registration to the wireless control unit (111) that confirms/acknowledges the reception of the demand followed by data relating to ID, terminal type, etc. to the multimedia terminal (101) which also confirms the reception of data from the control unit (111).

After performing an operation like this, a virtual connection is established between the registered control unit (111) and the multimedia terminal (101), ensuring that the multimedia content an the multimedia terminal (101) can only be accessed by one or more “registered” control unit(s) (111). Preferably, such an operation is required before all other communication may take place between a control unit (111) and a multimedia terminal (101).

FIG. 6c shows an example of a data transmission from a control application on a multimedia terminal (101) via a communication unit (110) for a wireless control unit (111) with expected response, where the transmission is done by transmitting data packages/packets.

First data package No. 1 is transmitted from the terminal (101), following which a confirmation of correct receipt of data package No. 1 is transmitted back to the terminal (101). This is repeated until all data packages/N data packages have been transferred correctly to the wireless control unit. Then a response is generated that is transmitted to the terminal (101) that returns a confirmation. Alternatively a response for each individual/one individual data package or a batch of data packages can be formed and returned to the terminal (101) following transmission of confirmation of receipt of the current data package(s). Then a confirmation of receipt of response will be transmitted from the terminal (101) for receipt by the control unit (111), following which any further data packages can be transmitted.

Preferably, the protocol also comprises the option of several wireless control units being able to communicate with a multimedia terminal (101). This can be accomplished e.g. by a registration of outer units/wireless control units (111) that must be suitable for use in connection with precisely this terminal (101), e.g. by each control unit (111) having a unique ID number that is recorded by the control application on the terminal (101). This unique ID number can thus be contained in any communication and thus identify the receiver and/or the sender (e.g. in each their data field). In this manner a simple solution to communication with several external units is provided.

Alternatively several control units may communicate directly with each other.

The application specific data concerns data depending on the application in use.

The protocol according to the present invention preferably also comprises error correction (e.g. error correction on spike or burst). The error correction method handles bit error(s) in crucial data bytes and performs Hamming correction on data. Alternatively, other error correction schemes may be used.

The protocol distinguishes between a telegram and a package in the following way.

Telegram is the raw data received before any error correction or reverse cryptography is done.

Package is the data part of the telegram after error correction and reverse cryptography is performed. The error correction method used preferably removes any error correction information.

An example of a structure of a telegram is shown below

| Byte | Type |
|---|---|
| 00 | PREAMBLE |
| 01 | PREAMBLE |
| 02 | PREAMBLE |
| 03 | PREAMBLE |
| 04 | START |
| 05 | START |
| 06 | FEC/CRYPT |
| 07 | LENGTH |
| 08 | RECIEVER |
| 09 | HAMMING |
| 10 | RECEIVER |
| 11 | TRANSMITTER |
| 12 | HAMMING |
| 13 | TRANSMITTER |
| 14 | SEQN |
| 15 | HAMMING |
| 16 | TYPE |
| 17 | DATA |
| 18 | HAMMING |
| 19 | DATA |
| 20 | DATA |
| 21 | HAMMING |
| 22 | DATA |
| 23 | DATA |
| 24 | HAMMING |
| | . |
| | . |
| | . |
| Length-4 | CHKSUM |
| Length-3 | CHKSUM |
| Length-2 | DUMMY |
| Length-1 | HAMMING |

An example of a structure of a package is shown below

| Byte | Type |
|---|---|
| 01 | FEC/CRYPT |
| 02 | LENGTH |
| 03 | RECEIVER |
| 04 | HAMMING |
| 05 | RECEIVER |
| 06 | TRANSMITTER |
| 07 | HAMMING |
| 08 | TRANSMITTER |
| 09 | SEQN |
| 10 | HAMMING |
| 11 | TYPE |
| 12 | DATA |
| 13 | HAMMING |
| | . |
| | . |
| | . |
| Length-4 | CHKSUM |
| Length-3 | CHKSUM |
| Length-2 | DUMMY |
| Length-1 | HAMMING |

The four PREAMBLE bytes are used to synchronize the wireless the receiver/transmitter. These bytes do not all have to be received. It is possible to receive only 2 or 3 of them. The PREAMBLE bytes are not part of the data packages according to the protocol.

PREAMBLE byte layout:

| | | | | | | | |
|---|---|---|---|---|---|---|---|
| Bit7 | Bit6 | Bit5 | Bit4 | Bit3 | Bit2 | Bit1 | Bit0 |
| F0 | | | | | | | |

The value of the PREAMBLE byte is always F0H.

The START bytes are used to identify a start of package. The receiver is constantly receiving noise signals and generates therefore random data or only 2 or 3 of the preamble bytes are received. The START bytes identify a starting frame.

START bytes layout:

| | | | | | | | |
|---|---|---|---|---|---|---|---|
| Bit7 | Bit6 | Bit5 | Bit4 | Bit3 | Bit2 | Bit1 | Bit0 |
| AA | | | | | | | |
| Bit7 | Bit6 | Bit5 | Bit4 | Bit3 | Bit2 | Bit1 | Bit0 |
| AA | | | | | | | |

The value of the START bytes is always MH.

A FEC/CRYPT byte is preferably used to inform about Hamming code type and cryptography type. The Hamming and cryptography bits are protected by parity bits located in the same byte.

FEC/CRYPT byte layout:

| | | | | | | | |
|---|---|---|---|---|---|---|---|
| Bit7 | Bit6 | Bit5 | Bit4 | Bit3 | Bit2 | Bit1 | Bit0 |
| CRYP1 | CRYPT0 | HAM1 | HAM0 | Par3 | Par2 | Par1 | Par0 |

CRYPT1, CRYPT0

The CRYPT bits are preferably used to select the cryptography format according to following table

| CRYP1 | CRYP0 | Description |
|---|---|---|
| 0 | 0 | No cryptogram |
| 0 | 1 | cryptogram format 1 (CRYPT METHOD #1) |
| 1 | 0 | cryptogram format 2 (CRYPT METHOD #2) |
| 1 | 1 | cryptogram format 3 (CRYPT METHOD #3) |

HAM1, HAM0

The HAM bits are used to select the Hamming format according to following table.

| HAM1 | HAM0 | Description |
|---|---|---|
| 0 | 0 | No hamming |
| 0 | 1 | hamming format 1 (FEC METHOD #1) |
| 1 | 0 | hamming format 1 (FEC METHOD #2) |
| 1 | 1 | hamming format I (FEC METHOD #3) |

PAR3, PAR2, PAR1, PAR0

The four parity bits is used to protect the CRYPT and HAM bits against transmission errors.

PAR1, PAR0 is used for vertical protection and PAR3, PAR2 is used for horizontal protection according to the following matrix:

| | | |
|---|---|---|
| CRYP1 | CRYP0 | PAR2 |
| HAM1 | HAM0 | PAR3 |
| PAR1 | PAR0 | |

Preferably, even parity is used.

LENGTH

The length byte contains number of bytes to be received/transmitted. The value of the LENGTH byte may be different in the telegram and in the package. In the telegram the LENGTH byte contains number of bytes from FEC/CRYPT to the last HAMMING byte, both bytes included. In the package the LENGTH byte is equal to that of the telegram. The value of the LENGTH byte will always be odd, see e.g. later.

LENGTH byte layout:

| | | | | | | | |
|---|---|---|---|---|---|---|---|
| Bit7 | Bit6 | Bit5 | Bit4 | Bit3 | Bit2 | Bit1 | Bit0 |
| Length | | | | | | | |

Range: 00H-FFH.

HAMMING

The HAMMING byte is used in connection with the error correction.

Every 2 bytes starting with the LENGTH byte is protected with a Hamming byte. If the length of the telegram is even a dummy byte is put at the end of the telegram in order to have 2 bytes for hamming protection. If hamming protection is not used (according to the bits in FEC/CRYPT byte, HAM0=0, HAM1=0) the Hamming byte is not sent in the telegram.

HAMMING byte layout:

| | | | | | | | |
|---|---|---|---|---|---|---|---|
| Bit7 | Bit6 | Bit5 | Bit4 | Bit3 | Bit2 | Bit1 | Bit0 |
| Par7 | Par6 | Par5 | Par4 | Par3 | Par2 | Par1 | Par0 |

Even parity is used.

RECEIVER

The RECEIVER bytes are part of the package.

RECIEVER bytes layout:

| | | | | | | | |
|---|---|---|---|---|---|---|---|
| Bit7 | Bit6 | Bit5 | Bit4 | Bit3 | Bit2 | Bit1 | Bit0 |
| Bit7 | Bit6 | Bit5 | Bit4 | Bit3 | Bit2 | Bit1 | Bit0 |

TRANSMITTER

The TRANSMITTER bytes are part of the package.

TRANSMITTER bytes layout:

| | | | | | | | |
|---|---|---|---|---|---|---|---|
| Bit7 | Bit6 | Bit5 | Bit4 | Bit3 | Bit2 | Bit1 | Bit0 |
| Bit7 | Bit6 | Bit5 | Bit4 | Bit3 | Bit2 | Bit1 | Bit0 |

SEQN

The SEQN byte contains the sequence number of the received/transmitted data and ACK/NACK packages.

The SEQN byte is part of the package.

SEQN byte layout:

| | | | | | | | |
|---|---|---|---|---|---|---|---|
| Bit7 | Bit6 | Bit5 | Bit4 | Bit3 | Bit2 | Bit1 | Bit0 |

Sequence number

The sequence number is used in connection with an ACK/NACK package and in connection with transmission of data in several packages.

The sequence number of an ACK/NACK package shall be the same as the sequence number in the received data package on which an ACK/NACK is required, elsewhere.

TYPE

The type byte contains information concerning acknowledgement, appended data and application.

TYPE byte layout:

| | | | | | | | |
|---|---|---|---|---|---|---|---|
| Bit7 | Bit6 | Bit5 | Bit4 | Bit3 | Bit2 | Bit1 | Bit0 |
| ACK | NACK | — | — | APEND1 | APEND0 | NOAPP | DACK |

DACK

The Demand Acknowledgement bit is used to inform the receiver if an ACK/NACK is required on the data package. The ACK/NACK is used at the transport layer.

DACK=0: The receiver shall not transmit ACK/NACK at reception of a package.

DACK=1: The receiver shall transmit ACK/NACK at reception of a package.

NOAPP

The No Application bit is used to inform the transport layer weather or not to forward a package to the application.

NOAPP=0: Application specific package.

NOAPP=1: Not application specific package.

APEND1, APPEND0

The append bits is used to inform the receiver weather or not the received data package is a single data package or a part of a sequence of data packages.

The append bits is set according to the following table

| APEND1 | APEND0 | Comment |
|---|---|---|
| 0 | 0 | Not meaningful at data transfer |
| 0 | 1 | SOB (Start Of data Block) |
| 1 | 0 | NOB ( Next part Of data Block) |
| 1 | 1 | EOB ( End Of data Block) |

ACK, NACK

The Acknowledgement/not Acknowledgement bits are used at the transport layer to inform the transmitting unit weather or not a data package has been correctly received.

The ACK/NACK bits is set according to following table

| ACK | NACK | Comment |
|---|---|---|
| 0 | 0 | Neither ACK or NACK received |
| 0 | 1 | NACK received |
| 1 | 0 | ACK received |
| 1 | 1 | Error state |

DATA

The DATA bytes contain the data to be processed by the system. The protocol according to the present invention preferably allows a maximum of 156 data bytes.

DATA bytes layout:

| | | | | | | | |
|---|---|---|---|---|---|---|---|
| Bit7 | Bit6 | Bit5 | Bit4 | Bit3 | Bit2 | Bit1 | Bit0 |
| Data | | | | | | | |

CHECKSUM

The checksum bytes are used to detect transmission errors.

The checksum is a simple addition between all the bytes from FEC/CRYPT to CHKSUM (FEC/CRYPT included).

The CHECKSUM bytes exist for both telegram and package. In the package the CHECKSUM bytes are recalculated.

CHECKSUM bytes layout.

| | | | | | | | |
|---|---|---|---|---|---|---|---|
| Bit7 | Bit6 | Bit5 | Bit4 | Bit3 | Bit2 | Bit1 | Bit0 |

Checksum

| | | | | | | | |
|---|---|---|---|---|---|---|---|
| Bit7 | Bit6 | Bit5 | Bit4 | Bit3 | Bit2 | Bit1 | Bit0 |

Checksum

DUMMY

The DUMMY byte is used if the number of bytes in the protocol package is even. The protocol package length shall be odd due to the hamming method used, see elsewhere.

DUMMY byte layout.

| Bit7 | Bit6 | Bit5 | Bit4 | Bit3 | Bit2 | Bit1 | Bit0 |
|---|---|---|---|---|---|---|---|
| 00 | | | | | | | |

The value of the DUMMY byte is always 00H.

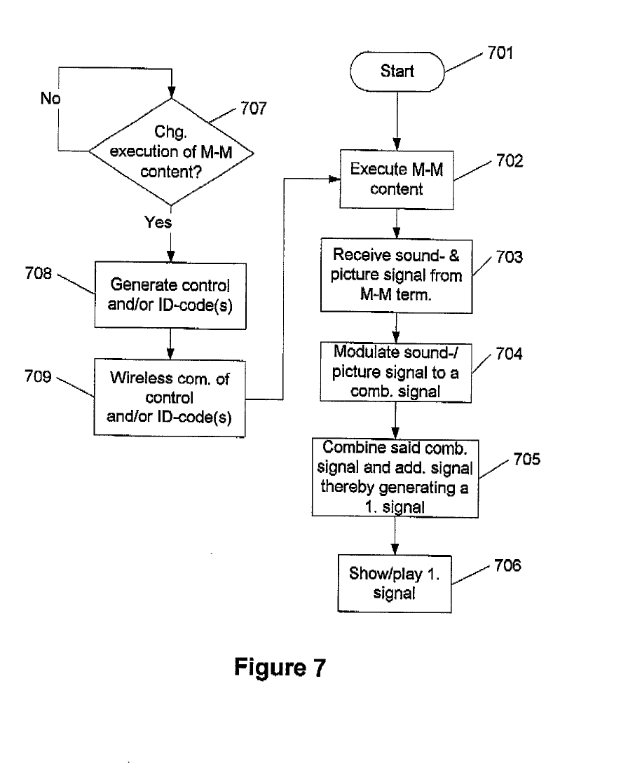

FIG. 7 illustrates a flowchart of an embodiment of a method according to the invention. The method starts in step (701). In step (702) multimedia content is executed by a suitable application on a multimedia terminal under the control of a control application as described elsewhere. The execution of multimedia content results in a sound and/or picture signal that is received in step (703) in a first unit as described elsewhere. The sound and picture signal is frequency modulated in step (704) to one single combined signal that is transmitted to and received in a second unit as described elsewhere, wherein it is combined in step (705) with a further signal, preferably comprising existing TV and/or radio channels, resulting in a first signal. In this way, the first signal comprises existing TV-channels and radio-channels (if any) and a standard radio channel signal comprising the sound generated by the multimedia terminal and a standard TV-channel signal comprising the sound and picture generated by the multimedia terminal. The first signal is transmitted via already installed hard-wired cabling, like standard coax cabling, and displayed/played in step (706) on/in one or more standard units, like a TV-set, a music-set, etc. as described above and in the following.

In step (707) it is decided whether the present multimedia execution is to be changed (e.g. start, stop, next. previous, wind/rewind, execution of other multimedia type, execution of other file, etc.). If the present execution of multimedia is not to be changed, the test (707) is performed later, either in accordance with a predetermined time interval or by interruption or request from e.g. a user interface on a control unit as described above. If the execution is to be changed, one or more control and/or ID codes are generated in a wireless control device in step (708) that reflect(s) the change selected/desired. These codes are subsequently (optionally along with further information) transferred wirelessly, in step (709), to the control application on the multimedia terminal, preferably via a communication unit/interface, as stated above, where the codes are interpreted, whereby a responsible multimedia execution application receives instructions to change the execution correspondingly.

Preferably steps (702-706) are executed in parallel with steps (707-709), wherein step (709) can continuously influence step (702).

Preferably the method also comprises communication to the control unit of current information/data, such as e.g. options, status, current multimedia execution, files, folders, etc, for presentation on a display or for further/internal use in the control unit.

The method has the same advantages for the same reasons as described elsewhere in connection with the system.

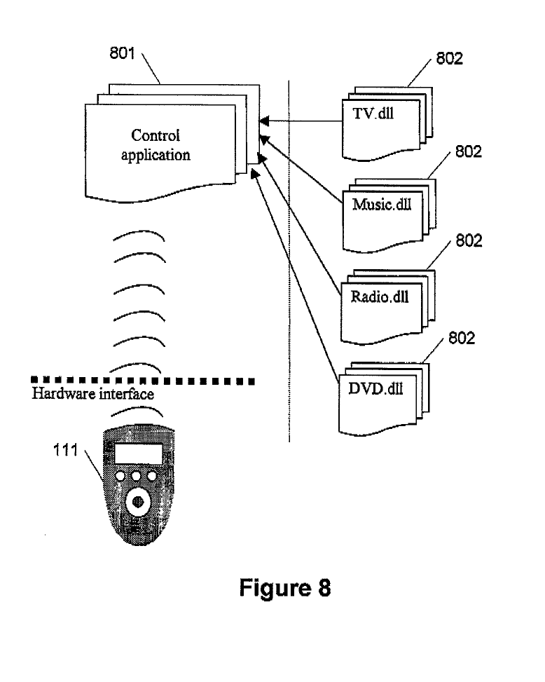

FIG. 8 schematically shows the communication between a control application on a multimedia terminal, a wireless control unit, and a number of applications for executing/playing multimedia content. Shown is a wireless control unit (111) that communicates, as described previously, with a control application (801) in a multimedia terminal via a hardware interface. The control application (801) receives commands, ID codes, relevant information and data, etc, from the unit (111) and in the light of this, controls one or more multimedia execution applications (802). The software control application (801) also receives current information from the multimedia execution applications (802), such as e.g. title, time left of multimedia content, format, file name, current folder, etc, for further processing and optionally transmission on to the unit (111) for use and/or presentation therein. Preferably, a DLL (dynamic linked library), program or application file exists for each type of multimedia content, e.g. a TV.dll, a music.dll, a radio.dll, a DVD.dll file, etc., where a specific component is responsible for handling its particular type of multimedia content. Each dll-component exchanges information with the control application responsible for retrieving and processing control codes from the wireless control device and is controlled by the control application (801). These program or DLL files may e.g. be specific written programs/(applications or standard programs available from a third party like winamp, powerDVD, media-player etc. This construction makes updating and/or addition of new multimedia functionality simple, since a new or updated multimedia execution (802) application file is merely to be installed and linked to the control application (801), e.g. by simple entering in the control application of path and name of the new/updated application. The software control application (801) and/or a multimedia execution application (802), e.g. TV.dll, is preferably also responsible for converting the terminal picture (e.g. VGA) into a format better suited for being viewed by a user on standard TVs. This e.g. involves converting the resolution, size of fonts, colours, etc. and is especially useful for viewing web pages on a standard TV-set. Additionally, the application (801) may also provide functionality to provide play-lists so a user does not have to care about whether e.g. a movie is accessible via the hard-drive, a network connection, etc. The play-list(s) may e.g. be provided by the user or a third party e.g. using a network/Internet connection.

The communication between the a control application on the multimedia terminal and the wireless control unit is preferably done according to the protocol described elsewhere which ensures a very simple control unit as most of the processing is done by the multimedia terminal and a minimum of information needs to be sent between them.

FIG. 9a illustrates an alternative embodiment of a first unit according to the invention. The embodiment corresponds to the one shown in FIG. 1b. Shown is a housing (901) that comprises the first unit and communications unit (104 and 110 in FIG. 1b) according to the embodiment shown in FIG. 1b.

FIG. 9b shows the embodiment from FIG. 9a from another angle. Shown is a housing (901) that comprises a power connector (902) for connecting with a power adapter/power supply, a connector (903) for connecting a pair of speakers, a combined sound/picture output (202) for the combined sound/picture signal (105 in Figs.1b), a video/TV/picture input (206) here in the form of a composite video IN input for receiving the picture signal from a TV-out from a VGA graphics adapter in the multimedia terminal, an analog sound input (205; 205′) (herein shown in the form of separate right and left sound inputs) for receiving the sound signal (103 in FIG. 1b) from a sound card in the multimedia terminal, a serial port (904) for connecting with a standard serial cable to a serial port on the multimedia terminal (114 in FIG. 1b), and a connector (905) for connecting with the communications interface (113 in FIG. 1b).

The serial port (904) is used to exchange information that is received from or is going to be transmitted to a wireless control unit via a communications unit between the first unit and the multimedia terminal. The connector (905) is used to transfer the same information between the first unit and the communications unit. Alternatively, the serial port may be a parallel or USB port.

Alternatively inputs (205) and (205′) can be combined in one single input. Besides input (206) can be another type of digital or analog output, e.g. RGB, D-Sub etc., directly from an output of a VGA graphics adapter in the multimedia terminal (101).

FIG. 9c illustrates an alternative embodiment of a communications interface according to the present invention. This communications interface (110) corresponds to the one shown in FIG. 3 with the exception that another type of connector is used for connecting it with (905) of FIG. 9b.

FIG. 10a illustrates a schematic diagram of an embodiment of a first unit according to the present invention. Shown is a first unit (104) that receives a picture (102) and sound (103) signal from a multimedia terminal like a multimedia computer, pc, etc. as described earlier. The first unit (104) preferably comprises a TV-modulator (121) receiving both the picture (102) and sound (103) signal and a radio-modulator (122) receiving the sound signal (103) only. The TV-modulator (121) modulates the picture signal (102) and the sound signal (103) so that the picture signal (102) with sound is preferably converted to the UHF-area resulting in a modulated picture and sound signal (102′). The picture signal (102) coming from a TV-out in the multimedia terminal is typically a low base-band frequency signal that may be displayed on a standard television as a signal on a special channel, i.e. it is not modulated with existing TV-channels. However, the modulation by the TV-modulator (121) enables the picture and sound signal to mixed with existing TV-channels and also renders the modulated signal (102′) more resistant to electrical interference and noise. Additionally, by modulating the sound and picture signals (102, 103) it is possible to connect them to the already existing TV-cabling of a typical home. The radio-modulator (122) modulates the sound signal so that a resulting modulated sound signal (103′) has a frequency in the normal FM radio frequency area thereby enabling the sound to be received and played in a standard music-set. Also shown is a summation-unit, combiner, etc. (120) for combining the modulated (stereo) sound signal (103′) and the modulated picture signal (102′) into a single combined signal (105). The first unit (104) may in one embodiment also comprise one or more amplifier circuits (not shown) for amplifying the signals if necessary.

FIG. 10b illustrates a schematic diagram of an embodiment of a second unit according to the present invention. Shown is a second unit (106) that receives a combined sound/picture signal (105) according to the invention from a first unit as described earlier. Further, the second unit (106) also receives, in one embodiment where the existing antenna arrangement has two plugs/outputs (one for TV and one for radio), an additional signal (107) comprising a TV signal (130) and a radio signal (131) from an existing TV-antenna, cable, etc. arrangement (not shown). A summation-unit, combiner, etc. (120) combines the combined signal (105) and the TV signal (131) comprising existing TV channels e.g. from a household TV antenna, cable provider, etc. into a first signal (108) comprising a TV-channel signal according to the present invention being fed to the household media display devices, like TV(s), etc. via the existing coax cabling. In this way, existing TV-channels and sound and picture from the multimedia terminal may be provided via the existing coax cabling already installed in the household. The radio signal (131) is also combined with a band-passed filtered version of the combined sound/picture signal (105) by a summation-unit, combiner, etc. (120) into a radio-channel signal (131′), i.e. a signal containing sound in the FM-band, comprising the existing radio channels and sound from the multimedia terminal which may be provided via existing coax-cabling to media play devices like music-set(s), etc. The filtering of the combined sound/picture signal is done by a band-pass filter (123), like a low-pass filter, that filters the picture part of the combined signal (105) so that it does not reduce the quality of or cause interference in the radio signal (131′).

In an alternative embodiment, where the existing antenna arrangement has one plug/output only (one comprising both TV and radio) a signal (130) containing both TV and radio (as indicated by a parenthesis around radio at signal 130) is combined with the combined sound/picture signal (105) from the first unit by a combiner (120) resulting in a first signal (108) comprising both existing radio-channels, existing TV-channels, sound and picture from the multimedia terminal in a single signal (130′). In this embodiment, the radio signal (131), band-pass filter (123), combiner (120) for these signals and the radio-only output (131′) are not necessary (although they may still be used).

FIG. 10c illustrates a schematic diagram of an embodiment of a communications interface according to the present invention. Shown are a communications interface (110) and a wireless control unit (111). The communications interface (110) comprises a communication receiver (Rx) (150) and transmitter (Tx) (151) being controlled by a control circuit (155) for communication with a wireless receiver/transmitter pair (Rx/Tx) (150′, 151′)) of the control unit (111). The control unit (111) further comprises one or more special or general-purpose microprocessors (157), a storage and/or memory (158) and a user interface (UI) (156) for interaction with a user. When the user selects, activates, uses, etc. a the user interface (156) a representation of the selection, preferably in the form of an ID code or control code, is transmitted to the multimedia terminal via the interface (110) for interpretation and reaction upon by the software application being responsible for executing and/or controlling the multimedia content on the terminal so that the intended change, selection, command, etc. is reflected.

FIG. 10d illustrates a schematic block diagram of a one embodiment of a multimedia terminal. Shown is a multimedia terminal (101), like a computer, PC, etc., for execution of a digital multimedia content/information, such as e.g. music, pictures, video, Internet radio, homepages, etc,. The multimedia terminal (101) comprises one or more microprocessors (170), a memory (171) like RAM, ROM and/or the like, a storage (176) like one or more hard disks, floppy-drives, etc., a network adapter (176) and/or a modem (not shown), a media drive (177) like a CD- ROM/CD-R/CD-RW/DVD reader/writer, an analog sound generator/card (172) for generating sound, and an analog display adapter (173) for producing a picture (typically being fed to a monitor/display). Additionally, the display adapter (173) also comprises a TV-out functionality (175) for outputting a converted version of the produced picture in a format that may be showed on a TV-set. The sound card (172) generates a sound signal (103) and the TV-out outputs a picture signal (102) according to the present invention, both being provided to a first unit (not shown) as explained elsewhere.

Alternatively said terminal (101) can be equipped with means for producing digital sound and/or picture signals. Such sound cards and video cards (both analogue and digital) are well known.

1. A system for providing a frequency modulated picture and sound signal on the basis of execution of multimedia content on a multimedia terminal, wherein the system comprises
a first unit (104) configured for receiving a sound signal (103) and a picture signal (102) from a multimedia terminal (101) configured for executing multimedia content, wherein the first unit (104) is further configured for frequency modulating and combining said sound signal (103) and picture signal (102) to one single combined picture and sound signal (105); and
a second unit (106) configured for receiving said combined picture and sound signal (105) and configured for combing said combined signal (105) with at least one further signal (107) resulting in a first signal (108).

2. A system according to claim 1, wherein said at least one further signal (107) comprises at least one signal selected from the group of:
a TV antenna signal; and
a radio antenna signal.

3. A system according to claim 1, wherein said system further comprises
said multimedia terminal (101);
a wireless communication unit (110) in communications connection with said multi-media terminal (101) and comprising a wireless receiver/transmitter (150, 151); and
a wireless control unit (111) comprising operation means (402; 403; 404; 405; 406; 407, 156) and a wireless receiver/transmitter (150′, 151′) and configured for two-way wireless communication with said communication unit (110);
wherein said control unit (111) is configured to control said execution of multimedia content on said terminal (101) via communication with said communication unit (110) and a software application (801) installed on said multimedia terminal (101).

4. A system according to claim 3, wherein said control unit (111) is configured for communicating with said wireless communication unit (110) in accordance with a simple protocol, wherein simple control codes are transmitted to said multimedia terminal (101) for receiving and processing by said software application (801), wherein said software application (801) is configured for execution and changing the execution of said multimedia content based on the received control codes.

5. A system according to claims 1, wherein said system further comprises at least one display and/or playing unit (109) that is configured for receiving and displaying and/or playing said first signal (108).

6. A system according to claim 5, wherein said at least one display and/or playing unit is selected from the group of:
a TV set;
a video player; and
a music set.

7. A system according to claim 1, wherein said first unit (104) comprises
a TV modulation unit (121), adapted to receive said picture signal (102) and said sound signal (103) from said multimedia terminal (101) and modulate said picture signal (102) and said sound signal (103) resulting in a frequency modulated picture and sound signal (102′),
a radio modulation unit (122), adapted to receive said sound signal (103) from said multimedia terminal (101) and modulate said sound signal (103) resulting in a frequency modulated radio signal (103′), and
a combination unit (120) adapted to combine said modulated picture and sound signal (102′) and said modulated radio signal (103′) into said single combined picture and sound signal (105).

8. A system according to claim 7, wherein said TV modulation unit (121) is adapted to modulate said picture (102) and sound (103) signal to the UHF frequency area, and said radio modulation unit (121) is adapted to modulate said sound signal (103) to the FM-radio frequency area.

9. A system according to claim 1, wherein said second unit (105) comprises a combination unit (120) connected to receive said further signal (107, 130), comprising TV and radio signals, and said combined signal (105) where said combination unit (120) is adapted to combine said further signal (107, 130) and said combined signal (105) resulting in said first signal (108, 130′) comprising existing TV and radio signals (130) and a frequency modulated version of said multimedia signal being executed on said multimedia terminal (101).

10. A system according to claim 1, wherein said second unit (105) comprises
a band-pass filter (123) connected to receive said combined signal (105) where said filter (123) is adapted to filter out a picture part of said combined signal (105) resulting in a filtered sound signal,
a first combination unit (120) connected to receive said combined signal (105) and said further signal (107, 130), comprising TV signals, where said first combination unit (120) is adapted to combine said further signal (107, 130) and said combined signal (105) resulting in said first signal (108, 130′) comprising existing TV signals (130) and a frequency modulated version of said sound and picture signal being executed on said multimedia terminal (101),
a second combination unit (120) connected to receive said filtered sound signal and said further signal (107, 131), where said second combination unit (120) is adapted to combine said further signal (107, 131) and said filtered sound signal resulting in said first signal (108, 131′) comprising existing radio signals (131) and a frequency modulated version of said sound signal being executed on said multimedia terminal (101).

11. A method of producing a frequency modulated picture and sound signal on the basis of execution of multimedia content on a multimedia terminal, wherein said method comprises
receiving a sound signal (102) and a picture signal (102) from a multimedia terminal (101) configured for execution multimedia content;
frequency modulation and combination of said sound signal and picture signal to one single combined picture and sound signal (105); and
combination of said combined signal (105) with at least one further signal resulting in a first signal (108).

12. A method according to claim 11, wherein said method further comprises
wireless communication between a wireless communication unit (110) connected to said multimedia terminal (101); and a wireless control unit (111) comprising operating means (402; 403; 404; 405; 406; 407, 156),
wherein said control unit (111) controls said execution of multimedia content on said multimedia terminal (101) via communication with said communication unit (110) and a software application (801) installed on said multimedia terminal (101).

13. A method according to claim 12, wherein said method further comprises wireless communication between said control unit and said wireless communication unit according to a simple protocol, wherein simple control codes are transmitted to said multimedia terminal (101) for receiving and processing by said software application (801); and wherein the application is configured for execution and/or changing the execution of said multimedia content based on the received control codes.

14. A method according to claims 11, wherein that the method further comprises receipt and display and/or playing of said first (108) signal in at least one display and/or playing unit (109).

15. A method according to claim 11, wherein said first unit (104) comprises
a TV modulation unit (121) receiving said picture signal (102) and said sound signal (103) from said multimedia terminal (101) and modulating said picture signal (102) and said sound signal (103) resulting in a frequency modulated picture and sound signal (102′),
a radio modulation unit (122) receiving said sound signal (103) from said multimedia terminal (101) and modulating said sound signal (103) resulting in a frequency modulated radio signal (103′), and
a combination unit (120) combining said modulated picture and sound signal (102′) and said modulated radio signal (103′) into said single combined picture and sound signal (105).

16. A method according to claim 15, wherein said TV modulation unit (121) modulates said picture (102) and sound (103) signal to the UHF frequency area, and said radio modulation unit (121) modulates said sound signal (103) to the FM-radio frequency area.

17. A method according to claim 11, wherein said second unit (105) comprises
a combination unit (120) receiving said further signal (107, 130), comprising TV and radio signals, and said combined signal (105) where said combination unit (120) combines said further signal (107, 130) and said combined signal (105) resulting in said first signal (108, 130′) comprising existing TV and radio signals (130) and a frequency modulated version of said multimedia signal being executed on said multimedia terminal (101).

18. A method according to claim 11, wherein said second unit (105) comprises
a band-pass filter (123) receiving said combined signal (105) where said filter (123) filter out a picture part of said combined signal (105) resulting in a filtered sound signal,
a first combination unit (120) receiving said combined signal (105) and said further signal (107, 130), comprising TV signals, where said first combination unit (120) combines said further signal (107, 130) and said combined signal (105) resulting in said first signal (108, 130′) comprising existing TV signals (130) and a frequency modulated version of said sound and picture signal being executed on said multimedia terminal (101),
a second combination unit (120) receiving said filtered sound signal and said further signal (107, 131), where said second combination unit (120) combines said further signal (107, 131) and said filtered sound signal resulting in said first signal (108, 131′) comprising existing radio signals (131) and a frequency modulated version of said sound signal being executed on said multimedia terminal (101).

19. A protocol for communication between a wireless control unit (111) and a multimedia terminal (101) wherein the protocol comprises:
simple control codes that are transmitted from said wireless control unit (111) to said multimedia terminal (101) for reception and processing by a software application (801) on said multimedia terminal (101); and
wherein said software application (801) is configured for execution and changing the execution of said multimedia content based on the received control codes.

20. A computer readable medium having stored thereon instructions for causing one or more processing units to execute the method according to claim 1.
